(19) United States
(12) Patent Application Publication
(10) Pub. No.: US 2010/0162861 A1
(43) Pub. Date: Jul. 1, 2010

(54) Peeling device and peeling machine

(76) Inventors: Alfred Bartz, Walhorn/Lontzen (BE); Michael Diethert, Erftstadt (DE); Dieter Diesinger, Herzogenrath (DE)

Correspondence Address: COLLARD & ROE, P.C., 1077 NORTHERN BOULEVARD, ROSLYN, NY, 11576, US

(21) Appl. No.: 12/584,878

(22) Filed: Sep. 14, 2009

(30) Foreign Application Priority Data
Sep. 15, 2008 (DE) 10 2008 047 363.4

(51) Int. Cl. B23B 5/12; B23B 3/26; B23Q 17/22

(52) U.S. Cl. 82/130; 82/131; 82/173

(57) ABSTRACT

In order to make available a peeling device and a peeling machine, respectively, in which peeling diameters that are set can be changed even under load, the invention proposes a peeling device having a rotating peeling head and having peeling chisels disposed on the latter, which chisels are radially adjustable by way of at least one setting drive, whereby the setting drive comprises a module that rotates with the peeling head, which module controls a setting gear mechanism by means of a relative movement that is undertaken with regard to the peeling head, in the direction of rotation.

The invention relates, on the one hand, to a peeling device having a rotating peeling head and peeling chisels disposed on the latter, which chisels can be adjusted radially by way of at least one setting drive. On the other hand, the invention relates to a peeling machine having such a peeling device.

Peeling machines, and, accordingly, also peeling devices of the type stated, are well known from the state of the art, whereby they can be used for cutting machining of semi-finished products configured in round and rod-shaped manner. For example, layers of scale are removed from a hot-rolled round material, in cutting manner, by means of peeling machines of the stated type, whereby the layer of scale is peeled from the mantle surface of the hot-rolled round material. In order to obtain particularly great production precision and thus a very good quality of such a peeled round material, not only a precise axial advance with regard to the round material or semi-finished product to be peeled is required. Instead, great diameter precision and great length precision of the peeled round material or semi-finished product are essential. Specifically in order to be able to achieve the latter properties, it is particularly important that the peeling machines comprise peeling devices that work in extraordinarily exact manner, which devices, in turn are equipped with a peeling head that works in particularly precise manner, by means of which the actual peeling machining of the round material or semi-finished product to be peeled is carried out.

Such a peeling machine of the type stated is known, for example, from the international patent application WO 2004/037471 A2. The peeling machine described there comprises a tool head that is equivalent to a rotating peeling head for peeling off a layer of scale, for example. The tool head has tool holders that can be adjusted relative to an axis of rotation, in which head the adjustable tool holders and a suitable setting device correspond with one another by way of specially shaped slide surfaces, in each instance, whereby the slide surfaces are configured to be essentially planar, or have a constant radius of curvature parallel to the axis of rotation of the tool head. It is true that in this way, the risk of critical wear in the region of the tool head can be reduced very well, so that on the one hand, complicated installation and maintenance work can be avoided and delayed as long as possible. On the other hand, the tool head can also work more precisely for a longer time because of lesser wear. However, it is disadvantageous in this connection that an adjustment of the tool head with regard to a peeling diameter cannot be carried out while peeling a semi-finished product, or can only be carried out insufficiently well. This disadvantage furthermore also relates to other known peeling machines and their peeling devices, respectively and particularly occurs in the case of peeling machines having large rated diameters for the work piece, particularly with rated diameters of more than 100 mm.

In this regard, it is the task of the present invention to make available a peeling device and a correspondingly suitable peeling machine, respectively, having large rated diameters, which devices and machines can be adjusted with regard to the peeling diameter, in precise and operationally safe manner, under load.

A first solution for the task proposes a peeling device having a rotating peeling head and peeling chisels disposed on the latter, which chisels can be radially adjusted by way of at least one setting drive, whereby the peeling device is characterized in that the setting drive comprises a module that rotates with the peeling head and is driven separately, which module controls a setting gear mechanism that rotates with the peeling head, by means of a relative movement that is undertaken with regard to the peeling head, in the direction of rotation.

In advantageous manner, in this way, relatively great setting forces can be applied in this way, even when the construction space that is available is very small, by means of which forces an adjustment of the rotating peeling head and of the corresponding adjustable peeling chisels, respectively, is possible even under load. In this connection, the separate drive particularly makes it possible for the setting gear mechanism to be precisely controlled in structurally simple manner, whereby preferably, precise regulation of the separately driven module takes place electronically. Complex mechanisms, which particularly result in additional weight and can also cause losses in precision because of their unavoidable play, are not necessarily required.

Precise regulation of the rotating and separately driven module can be implemented, in particularly simple manner, if the module stands in a rotational drive connection with a fixed setting drive motor.

It is understood that a setting gear mechanism that is suitable in this regard can have many different forms. A roller gear mechanism has proven to be particularly advantageous in this connection.

Thus, another solution for the task of the invention proposes a peeling device having a rotating peeling head and having peeling chisels disposed on the latter, which can be adjusted radially by way of at least one setting drive, whereby the peeling device is characterized in that the setting drive comprises a setting gear mechanism that rotates with the peeling head, which is configured as a roller gear mechanism.

In advantageous manner, the setting drive can be built in extraordinarily compact manner if it comprises a roller gear mechanism. Furthermore, setting of the peeling chisels can take place very precisely and also under tremendous load by means of a roller gear mechanism, so that in particular, the peeling device can be adjusted with regard to its peeling diameter, in precise and operationally safe manner, under load.

In particular, if the roller gear mechanism is driven by a rotating module of the setting drive, which module stands in a rotational drive connection with a fixed setting drive motor, the present rotating peeling head can be built in particularly compact manner. For example, in this connection, it is advantageous that no other drive components or gear mechanism components between the setting drive motor and the roller gear mechanism are required for operating the roller gear mechanism.

Furthermore, it is advantageous if the rotational speed of the fixed setting drive motor is regulated as a function of the rotational speed of the peeling head. In this way, a particularly simple control possibility, particularly with regard to the adjustable peeling chisels, can be achieved, since merely a relative movement has to be changed for control, with regard to the rotational speed of the fixed setting drive motor, if the setting drive is supposed to go into effect. Alternatively to this, the drive of the peeling head can be regulated, in terms of its circumferential speed, in accordance with the circumferential speed of the fixed setting motor or of the rotating module, respectively. However, this is more complicated to implement, in terms of process technology, but nevertheless it can be viewed as an interesting although not as elegant alternative.

It is particularly advantageous if the roller gear mechanism is driven by a setting drive motor that rotates along on the peeling head. In this connection, the setting drive motor that rotates along can interact directly with the setting drive of the adjustable peeling chisels. In this regard, the rotating peeling head can carry other essential components with it, and can be built even more compactly, in advantageous manner.

Depending on the concrete embodiment, in the present case, a single setting drive motor that rotates along can already be sufficient to drive all the adjustable peeling chisels to a sufficient degree.

However, it can also be advantageous if a setting drive motor that rotates along is provided per adjustable peeling chisel, thereby making it possible to achieve the result, in particularly promising manner, that the individual power per setting drive motor does not have to be designed to be too great. In this regard, the individual setting drive motors can be selected to be relatively small, thereby making it possible to implement them in space-saving manner. This solution, however, along with its advantages, has the disadvantage that a relatively large amount of energy has to be transferred on the rotating peeling head, whereby this disadvantage can be taken into account by means of slower adjustment speeds, which in turn can be implemented without problems with regard to special embodiments with regard to the peeling device.

Furthermore, the task of the invention is accomplished by a peeling device having a rotating peeling head and having peeling chisels disposed on the latter, which chisels can be radially adjusted by way of at least one setting drive, whereby a self-inhibiting setting gear mechanism is provided between the peeling chisels and the setting drive. In advantageous manner, it is easily possible that only adjustment forces have to be applied for setting the peeling chisels, by means of such a self-inhibiting setting gear mechanism. Then, no additional positioning or holding forces, for example for holding the set peeling chisels in a predetermined working position, have to be applied by one or more setting drive motors. In this way, as well, the peeling device can be adjusted in precise and operationally safe manner, under load, with regard to its peeling diameter.

Furthermore, another solution of the task of the invention provides a peeling device having a rotating peeling head and having peeling chisels disposed on the latter, which chisels can be radially adjusted by way of at least one setting drive, whereby the peeling device is characterized by at least one measurement device that rotates along with the peeling head, for measuring one or more peeling chisel positions.

If such a measurement device is rotating directly with the peeling head, the peeling chisel positions can be measured very exactly, thereby making it possible to also set the individual peeling chisels against a semi-finished product or tool to be peeled in extraordinarily precise manner. In particular, by means of the measurement device that rotates along, a very precise regulation circuit for setting the peeling chisels can also be guaranteed.

Not only in this connection can the measurement taken with regard to the chisel position be checked cumulatively, by means of a separate measurement check of the peeled semi-finished product or work piece, which only takes place farther away from the rotating peeling head, for space reasons or contamination reasons, and thus only significantly later. For example, in this way, it is possible to advantageously react to wear of the adjustable peeling chisels, which would distort the latter measurement result.

Also by means of such a measurement method, an adjustment of the peeling device with regard to its peeling diameter, under load, can take place in precise and operationally safe manner.

If necessary, such a separate measurement check can also take place by way of a measurement system that rotates along, if there is sufficient space left in the region of the peeling head in order to accommodate such a measurement system that rotates along there, and if furthermore, it can be guaranteed, at the same time, that this measurement system will function reliably even under the most adverse conditions, such as, for example, severe component vibrations, dirt particles, and/or work emulsions, such as water.

Cumulatively, the task of the invention is also accomplished by a peeling device having a rotating peeling head and having peeling chisels disposed on the latter, which chisels can be radially adjusted by way of at least one setting drive, whereby the peeling device is characterized by at least one absolute measurement device for measuring one or more peeling chisel positions.

Advantageously, the precise position of the adjustable peeling chisels can always be indicated by means of such an absolute measurement device, for example even immediately after a power failure. This is particularly advantageous in view of the adverse conditions that prevail during peeling, which can certainly cause power failures with regard to the peeling head for short periods of time, even if other regions of the peeling device or a peeling machine are not directly affected by this. This is not critical, up to a certain degree, since an adjustment of the peeling chisels on the peeling head generally does not take place for a very short time and within a short time, in any case. If necessary, the power supply for components on the peeling head that function electrically and/or electronically, i.e. for the measurement devices, can be intentionally interrupted without problems, in order to save energy in this manner.

Preferably, two or more measurement devices that rotate along with the peeling head are provided for measuring one or more peeling chisel positions, in order to thereby be able to advantageously further increase the measurement accuracy of the measurement devices that rotate along. Furthermore, a redundancy of functionally particularly important components can be made available on the present peeling device by means of the presence of multiple measurement devices, thereby making it possible to reduce the risk of failure of the entire peeling machine, for example due to critical contamination of a measurement device that rotates along. It is understood that the measurement devices used can be configured identically, in order to be able to guarantee the redundancy that has been explained in structurally simple manner.

However, measurement devices that work in different ways can also be advantageously provided on the peeling head that rotates along.

Specifically, a preferred embodiment can thus also provide that the peeling device has at least two measurement devices for measuring one or more peeling chisel positions that rotate along with the peeling head, whereby one of the two measurement devices that rotate along comprises an absolute measurement device, and another of the two measurement devices that rotate along comprises an incremental measurement device. By means of such a combination of measurement devices that work in different ways, the measurement accuracy at the peeling device can be increased significantly once again.

An absolute measurement device can, as already explained, almost always immediately measure the precise position of the peeling chisels in this connection, advantageously even after an interruption of the electrical supply to the measurement device that rotates along, in each instance. Such an interruption can occur unintentionally, for example, by means of a corresponding failure of an electrical power system, or can be brought about intentionally, by means of targeted shut-off of the electrical supply in this regard, for example if measuring the peeling chisel positions is not required.

An incremental measurement device can be used, for example, for verifying and/or correcting the measurements taken by means of the absolute measurement device, thereby also making it possible to achieve an improvement in the operational safety of the peeling device. In this connection, the incremental measurement device can measure the position change of the individual peeling chisels proceeding from a reference point. In particular, this is advantageous if sufficient measurement resolution cannot be achieved by means of the absolute measurement device.

Furthermore, it is advantageous if the peeling device is characterized by wireless transmission of the measurement values determined, from the measurement device that rotates along to a fixed unit. Wireless transmission that is suitable in this regard can be configured in many different ways. For example, suitable wireless transmission of measurement values can take place by means of light or inductively, whereby bi-directional wireless transmission can also be provided, depending on the concrete measurement device that rotates along. For example, the fixed unit can be implemented by means of a control device of a measurement system of the peeling device, or by means of an external computer on a peeling device. Likewise, measurement values of other measurement devices situated on the peeling head can also be transmitted in wireless manner.

The task of the invention is also accomplished by a peeling device having a rotating peeling head and having peeling chisels disposed on the latter, which chisels can be radially adjusted by way of at least one setting drive, in which at least one direct measurement device is provided for measuring one or more peeling chisel positions. Very precise measurement values with regard to the peeling chisel positions can be determined by means of measurement devices that measure directly.

The term “direct measurement” describes a device and/or a method for measuring one or more peeling chisel positions in which the peeling chisel positions can be determined directly, thereby making it possible for the measurement values to be present as undistorted as possible.

In this connection, it is advantageous if the direct measurement takes place by way of a rigid intermediate element, preferably a peeling chisel shaft. If the direct measurement takes place by way of such a rigid intermediate element, the measurement accuracy can be significantly increased in this way, since movable intermediate elements in themselves can lead to greater measurement inaccuracies, because of the tolerances that result from this.

Furthermore, the task of the invention is also accomplished by a peeling device having a rotating peeling head and peeling chisels disposed on the latter, which chisels can be radially adjusted by way of at least one setting drive, whereby the peeling device is characterized by a contact-free energy supply of consumers that run along on the peeling head.

By means of such an inductive energy supply, supply to the electrical consumers can take place in operationally safe manner, even under very adverse ambient conditions, such as dirt and moisture, in particular. In this regard, the peeling device can always be adjusted in very precise and operationally safe manner, even in case of severe contamination.

An inductive energy supply is a particular possibility as a contact-free energy supply. This is particularly simple to implement and, if necessary, other information can also be transferred, in wireless manner, between the rotating peeling head and the modules that are affixed on it, and the fixed modules of the peeling device, if necessary, by way of this. However, the data transmission can also take place electromagnetically or optically or in some other way.

Cumulatively or alternatively, the energy supply of the electrical consumers that rotate with the rotating peeling head can be ensured by means of an energy source that rotates along, such as a rechargeable battery and/or a battery. In this connection, the rechargeable battery or the battery, respectively, can be attached directly onto the rotating peeling head.

Finally, the task of the invention is accomplished by a peeling machine having a peeling device, whereby the peeling device has at least one of the characteristics described above, or one of the combination of characteristics described above.

The present peeling device can be used to particular advantage on peeling machines having a machining capacity, with regard to a semi-finished product diameter, of up to 600 mm and more, in particular. On the other hand, it is understood that under special circumstances, the present invention can also be used for peeling machines having smaller rated diameters.

Additional advantages, goals, and properties of the present invention will be described using the following explanation of the attached drawing, in which a first exemplary embodiment of a peeling device having a rotating peeling head, as well as a peeling machine equipped with it, are shown as an example.

The drawing shows:

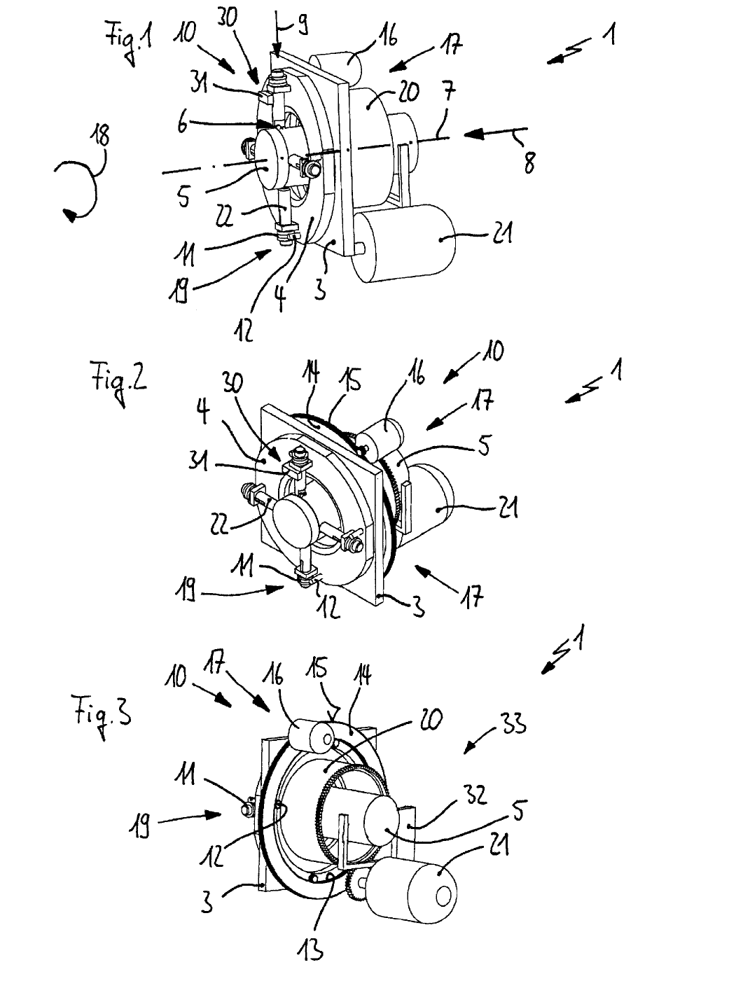

FIG. 1 schematically, a perspective detail view of a peeling device according to the invention;

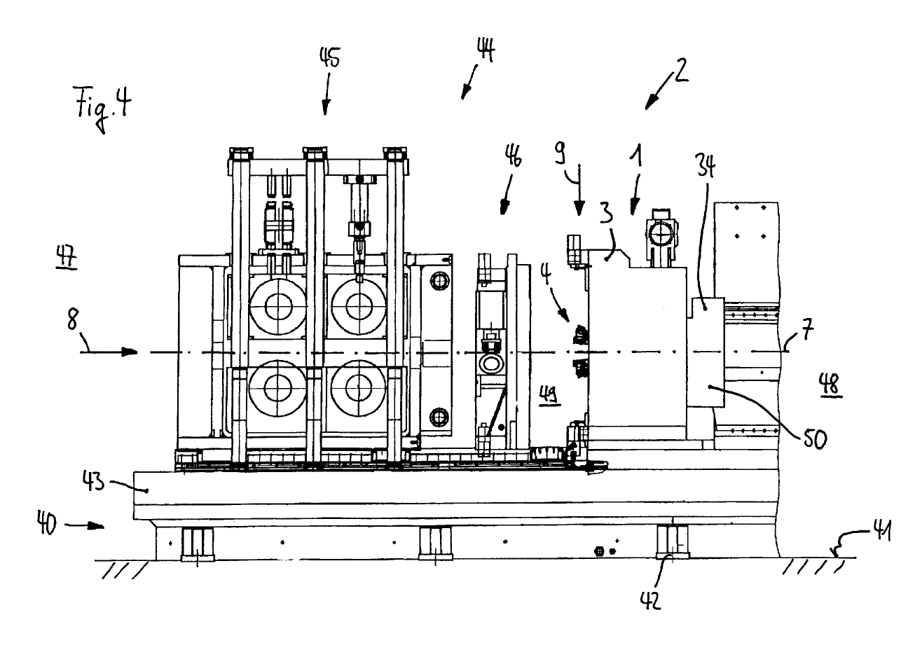

FIG. 2 schematically, another perspective detail view of the peeling device according to FIG. 1;

FIG. 3 schematically, a rear perspective detail view of the peeling device according to FIGS. 1 and 2;

FIG. 4 schematically, a view of a peeling machine equipped with the peeling device according to FIGS. 1 to 3;

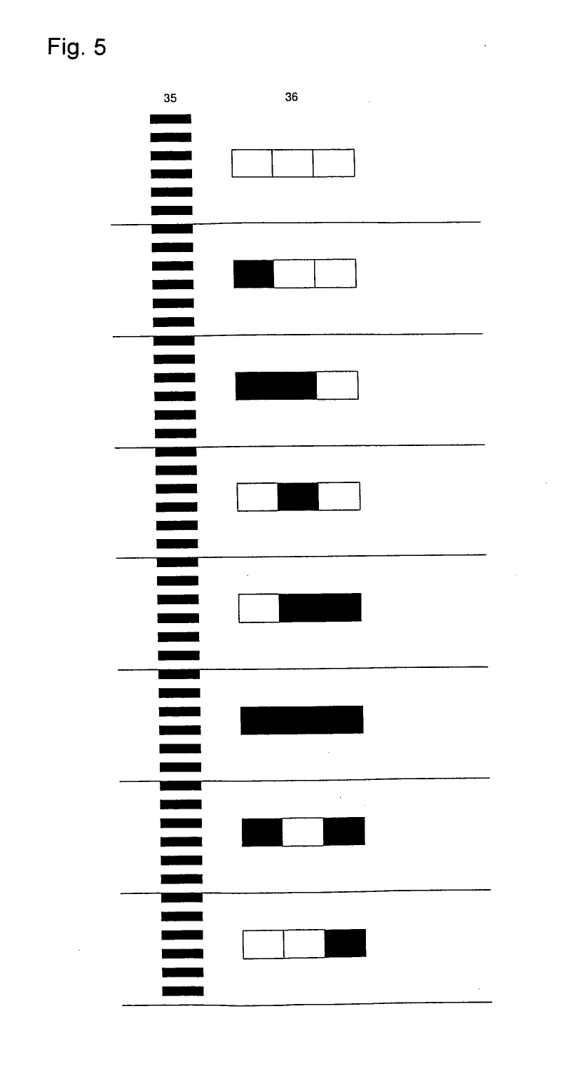

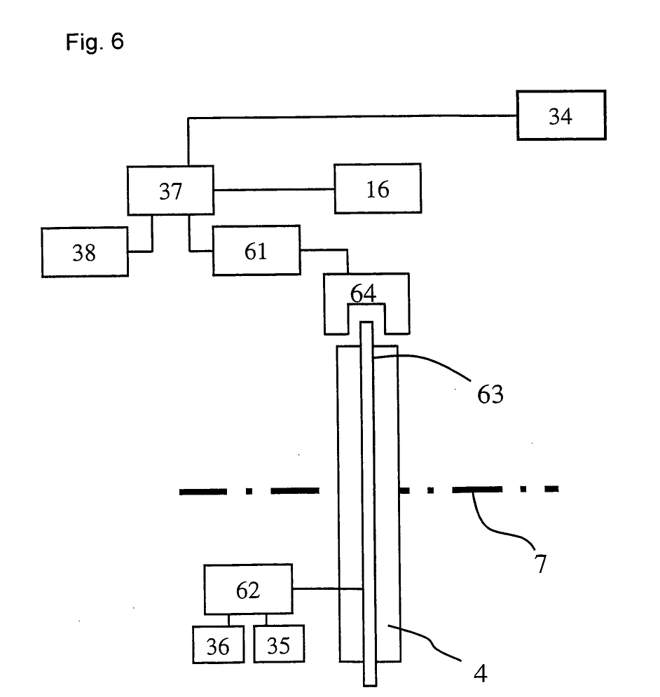

FIG. 5 a schematic representation of the measurement systems of the peeling device; and

FIG. 6 a schematic representation of the regulation and control of the peeling device.

The peeling device 1 shown in FIGS. 1 to 3 can be integrated into a peeling machine 2 (see FIG. 4), whereby the peeling device 1 is fixed in place in a corresponding machine frame 3 of the peeling machine 2.

The peeling device 1 comprises a rotating peeling head 4, through which a work piece 5 to be peeled can be moved in linear manner, and a total of four adjustable peeling chisels 6 (which are numbered only as examples here, for the sake of clarity), which can rotate with the rotating peeling head 4.

In this connection, the work piece 5 to be peeled can be transported through the peeling machine 2 axially along a machining segment 7, so that the work piece 5 finally can also be transported, in linear manner, through the rotating peeling head 4, in the transport direction 8.

The adjustable peeling chisels 6 can be moved toward the machining segment 7 in the radial direction 9 (shown only as an example), in each instance, whereby specifically in this exemplary embodiment, four peeling chisels 6, in total, are movably mounted in the rotating peeling head 4, concentrically around the machining segment 7.

Each of the adjustable peeling chisels 6 can be adjusted by means of a setting drive 10. The setting drive 10 comprises worm wheels 11 and worm shafts 12, whereby the worm shaft 12, in each instance, is particularly connected to interact with an inner gearing 13 of a gear crown 14 of the setting drive 10. The gear crown 14 furthermore possesses an outer gearing 15, by way of which a setting drive motor 16 stands in engagement with the gear crown 14. When the setting drive motor 16 is activated, the individual adjustable peeling chisels 6 can be moved either toward the machining segment 7 or away from the machining segment 7.

In the present case, not only the worm wheels 11 and worm shafts 12, in each instance, can rotate with the rotating peeling head 4; instead, in advantageous manner, the gear crown 14 also rotates, so that the setting drive 10 comprises a module 17 that rotates with the rotating peeling head 4, which module controls a setting gear mechanism 19 by means of a relative movement undertaken with regard to the rotating peeling head 4, in the direction of rotation 18, whereby the setting gear mechanism 19 consists at least of one of the worm shafts 12 and one of the worm wheels 11. In this regard, such a rotating setting gear mechanism 19 is configured as a roller gear mechanism, so that it is configured to be complex, and, at the same time, robust.

The rotational speed of the fixed setting drive motor 16 is regulated, in the case of this exemplary embodiment, as a function of the rotational speed of the rotating peeling head 4, whereby the rotating peeling head 4 is driven, in this connection, by way of a hollow shaft 20, by means of a main drive motor 21 of the peeling device 1.

In this exemplary embodiment, the fixed setting drive motor 16 is attached to the machine frame 3, whereby alternatively, it can also rotate with the rotating peeling head 4, if a sufficiently large construction space is provided in the region of the rotating peeling head 4.

By means of such a relative movement, the peeling chisel shafts 22, in each instance, on which the adjustable peeling chisels 6 are held, can be displaced radially relative to the machining segment 7 by means of the setting gear mechanism 19, in each instance, thereby making it possible to guarantee particularly exact adjustment of the adjustable peeling chisels 6 in the radial direction 9.

In order to be able to measure such a setting movement particularly exactly, the peeling device 1 has at least one measurement device 30 that rotates along with the rotating peeling head 4, for measuring one or more peeling chisel positions. In this connection, the measurement device 30 that rotates along has a measurement value sensor 31 that can measure the precise position of a peeling chisel both absolutely and incrementally. It is understood that such measurement value sensors 31 can be provided for each peeling chisel, which is particularly advantageous if each peeling chisel is adjustable individually. In the present exemplary embodiment, this is not necessary, since all the peeling chisels are mechanically coupled by way of the inner gearing 13 and the gear crown 14.

The measurement system 33 furthermore has a diameter measurement device 34 (see FIG. 4), by means of which a work piece diameter of the work piece 5 can be measured exactly, particularly in connection with the measurement device 30 that rotates along. In this regard, a laser curtain can be used, for example, with which diameters can be determined to precisions of nm (nanometers), whereby it can be assumed, because of the rotating peeling process, that one diameter measurement is sufficient, and it is not necessary to measure multiple diameters at different setting angles.

In order to be able to reliably supply sensors, in particular (not shown explicitly here) or other electronic or electrical components (also not shown explicitly here) of the measurement device 30 that rotates along with electrical energy, the peeling device 1 has an inductive energy supply for electrical consumers that rotate along on the rotating peeling head 4.

The peeling device explained here can, as was already described initially, be used to particular advantage on peeling machines 2 in accordance with the representation according to FIG. 4.

The peeling machine 2 has a machine frame 40 that is attached to a substratum 41 by means of attachment anchors 42 (numbered only as examples here). The machine frame 40 comprises a traverse 43 on which the peeling device 1 is disposed. Ahead of the peeling device 1, an advancing device 44 is disposed on the traverse 43, in displaceable manner. The advancing device 44 comprises an advancing apparatus 45 and a run-in guide 46. The work piece 5 to be peeled can be moved, by means of the advancing apparatus 45, from an inlet region 47, through the peeling machine 2, to an outlet region 48, whereby the work piece 5 to be peeled can be guided to the peeling device 1 or the rotating peeling head 4, respectively, in particularly exact manner, by means of the run-in guide 46.

Because both the advancing apparatus 45 and the run-in guide 46 are disposed on the traverse 43 in displaceable manner, an assembly space 49 can be created, particularly directly ahead of the peeling device 1, when the advancing apparatus 45 or the run-in guide 46, respectively, are moved away from the peeling device 1. Accordingly, work on the peeling head 4 can advantageously be performed, particularly with regard to the measurement system 33 of the peeling device 1.

A diameter measurement of the peeled work piece 5 can be carried out behind the peeling device 1, by means of the diameter measurement device 34, which is accommodated behind a run-out guide 50 of the peeling machine 2.

The measurement value sensor 31 of this exemplary embodiment, which works both absolutely and incrementally, is designed in such a manner that 10 nm can be resolved incrementally, while the absolute resolution is higher by a factor of 10, as is indicated schematically in FIG. 5. In this connection, the absolute transducer system 36 is configured as a Gray code, in order to minimize error sources. It is then easily possible, using a corresponding magnetic marking, to determine the absolute position to a precision of 100 nm. Fine-tuning then takes place, as will be explained in greater detail below, by way of the incremental transducer system 35.

For this purpose, the diameter of the peeled work piece is determined by way of the diameter measurement device 34, and passed on to a memory-programmable control 37, or to another correspondingly suitable computer unit. Now, a corresponding control command can be issued to the setting drive motor 16, in accordance with the default shown by way of a setting element 38.

Control of the setting drive motor 16 can take place with a precision of 10 nm, in accordance with the defaults from diameter measurement device 34 and setting element 38, by means of the measurement values from the incremental transducer system 35, which are transferred to a coil 63 of the inductive energy supply by way of rotor electronics 62, and read out by a pick-up 64, by way of stator electronics 61.

Relatively precise machining can be guaranteed by way of the absolute transducer system 36, particularly after a shut-down or at times when a machined work piece has not yet reached the diameter measurement device 34, thereby making it possible to reduce scrap to a minimum.

### REFERENCE SYMBOL LIST

1 peeling device
2 peeling machine
3 peeling machine frame
4 rotating peeling head
5 work piece to be peeled
6 adjustable peeling chisel
7 machining segment
8 transport direction
9 radial direction
10 setting drive
11 worm wheel
12 worm shaft
13 inner gearing
14 gear crown
15 outer gearing
16 setting drive motor
17 rotating module
18 direction of rotation
19 setting gear mechanisms
20 hollow shaft
21 main drive motor
22 peeling chisel shaft
30 measurement device that rotates along
31 measurement value sensor
32 fixed measurement unit
33 measurement system
34 diameter measurement device
35 incremental transducer system
36 absolute transducer system
37 memory-programmable control
38 setting element
40 machine frame
41 substratum
42 attachment anchor
43 traverse
44 advancing device
45 advancing apparatus
46 run-in guide
47 inlet region
48 outlet region
49 assembly space
50 run-out guide
61 stator electronics
62 rotor electronics
63 coil
64 pick-up

1. Peeling device (1) having a rotating peeling head (4) and having peeling chisels (6) disposed on the latter, which chisels are radially adjustable by way of at least one setting drive (10), wherein the setting drive (10) comprises a module (17) that rotates with the peeling head (4) and is driven separately, which module controls a setting gear mechanism (19) that rotates with the peeling head, by means of a relative movement that is undertaken with regard to the peeling head (4), in the direction of rotation (18).

2. Peeling device (1) according to claim 1, wherein the rotating and separately driven module (17) stands in a rotational drive connection with a fixed setting drive motor (16).

3. Peeling device (1) having a rotating peeling head (4) and having peeling chisels (6) disposed on the latter, which chisels are radially adjustable by way of at least one setting drive (10), particularly also according to claim 1, wherein the setting drive (10) comprises a setting gear mechanism (19) that rotates with the peeling head (4), which is configured as a roller gear mechanism.

4. Peeling device (1) according to claim 3, wherein the roller gear mechanism is driven by a rotating module (17) of the setting drive (10), which module stands in a rotational drive connection with a fixed setting drive motor (16).

5. Peeling device (1) according to claim 1, wherein the rotational speed of the fixed setting drive motor (16) is regulated as a function of the rotational speed of the peeling head (4).

6. Peeling device (1) according to claim 3, wherein the roller gear mechanism is driven by a setting drive motor that rotates along on the peeling head (4).

7. Peeling device (1) having a rotating peeling head (4) and having peeling chisels (6) disposed on the latter, which chisels are radially adjustable by way of at least one setting drive (10), particularly also according to claim 1, wherein a self-inhibiting setting gear mechanism is provided between the peeling chisels (6) and the setting drive (10).

8. Peeling device (1) having a rotating peeling head (4) and having peeling chisels (6) disposed on the latter, which chisels are radially adjustable by way of at least one setting drive (10), particularly also according to claim 1, further comprising at least one measurement device (30) for measuring one or more peeling chisel positions, which device rotates along with the peeling head (4).

9. Peeling device (1) having a rotating peeling head (4) and having peeling chisels (6) disposed on the latter, which chisels are radially adjustable by way of at least one setting drive (10), particularly also according to claim 1, further comprising at least one absolute measurement device for measuring one or more peeling chisel positions.

10. Peeling device (1) according to claim 1, further comprising at least two measurement devices (30) for measuring one or more peeling chisel positions, which devices rotate along with the peeling head (4), whereby one (30) of the two measurement devices that rotate along comprises an absolute measurement device, and another of the two devices that rotate along comprises an incremental measurement device.

11. Peeling device (1) according to claim 8, further comprising wireless transmission of the measurement values determined, from the measurement device (30) that rotates along to a fixed unit (32).

12. Peeling device (1) having a rotating peeling head (4) and having peeling chisels (6) disposed on the latter, which chisels are radially adjustable by way of at least one setting drive (10), particularly also according to claim 1, further comprising at least one direct measurement device for measuring one or more peeling chisel positions.

13. Peeling device (1) according to claim 12, wherein the direct measurement takes place by way of a rigid intermediate element, preferably a peeling chisel shaft (22).

14. Peeling device (1) having a rotating peeling head (4) and having peeling chisels (6) disposed on the latter, which chisels are radially adjustable by way of at least one setting drive (10), particularly also according to claim 1, further comprising a contact-free energy supply of consumers that rotate along on the peeling head (4).

15. Peeling device (1) according to claim 14, wherein the contact-free energy supply is configured inductively.

16. Peeling device (1) according to claim 14, wherein the contact-free energy supply comprises an energy source that rotates along.

17. Peeling machine (2) having a peeling device (1) according to claim 1.
